(19) United States
(12) Patent Application Publication
(10) Pub. No.: US 2006/0238537 A1
(43) Pub. Date: Oct. 26, 2006

(54) Screen display method and device and program for the same

(76) Inventor: Keisuke Nakamura, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/544,592

(22) PCT Filed: Feb. 5, 2004
(86) PCT No.: PCT/JP04/01192

§ 371 Date: Apr. 18, 2006

(30) Foreign Application Priority Data
Feb. 5, 2003 (JP) 2003-028935

(51) Int. Cl. G06T 11/20

(52) U.S. Cl. 345/440

(57) ABSTRACT

There is provided a knowledge (information) providing type display method, especially a screensaver, offering a benefit to a lot of people who watch simultaneously by giving them motivation to look at a knowledge item shown adjacent to a knowledge item which is too easy or too difficult. A plurality of knowledge or information items are simultaneously or successively displayed in different continuous position or order on the same screen according to the knowledge use frequency, the understanding degree, and the difficulty level.

### TECHNICAL FIELD

This invention relates to method for displaying knowledge and/or information on screen. In particular, this invention relates to environment to which those who watch the screen are not assumed to input anything, especially screensaver, and also to screen display device and computer program for the same.

### BACKGROUND ART

In prior art, in case of displaying knowledge or information items as screensaver, they are displayed one by one (for example “OboeruScreenSaver”; http://knowrel.com) or they are simultaneously displayed at screen locations according to positions of field sphere or knowledge system (for example, Japanese patent application 2002-194019, which is not disclosed, and was invented by the same inventor as the present invention).

However, in case of knowledge displayed one by one, those who know the displayed knowledge or information may be bored, and in case of knowledge displayed at different screen locations according to positions of field sphere or knowledge system, there is no reason for watching knowledge etc. that are displayed on position adjacent to the position on which boring knowledge etc. are displayed, so the value of screensaver as knowledge transmission channel had been limited.

Therefore, those who are at too low level in comparison with knowledge level being displayed then may give up watching, or have to learn less important knowledge (which it is not efficient for low-level proficient person then to learn and which are used less frequently ), and too high-level proficient person may quit watching the knowledge or may be bored. Consequently, it occurs scarcely that many people at different levels watch same screensaver simultaneously and gain by it, and such knowledge-providing screensaver had not been commonly used in public space and the like.

The purpose of the present invention is, therefore, to provide knowledge (information) providing type display method, in particular screensaver, in which there is some reason for watching knowledge displayed adjacent to knowledge that are boring or too difficult and by which many people watch screen simultaneously and gain.

### DISCLOSURE OF THE INVENTION

The present invention is screen display method for the purpose, characterized in that it displays, simultaneously or one bye one, a plurality of knowledge or information (hereinafter, we call them simply as knowledge), in particular on same screen, at different continuous or not-continuous positions or in such order according to the knowledge use frequency, the understanding degree, or the difficulty level. Therefore, all people can get new knowledge from the screen display accordingly to the knowledge levels, by moving their eye to not-boring direction in case of boring knowledge and by moving their eye to easier direction in case of too difficult knowledge. Moreover, those who can answer quickly one question as to knowledge and/or those who want remember many words at once can try many question and/or remember many words during one question-answer quiz phase by the present invention. Moreover, those who want remember words with positional relationship of the words on screen can more efficiently remember by the classified display policy (order and/or topology) of the present invention.

For example, the present invention may display tree in which common question setting parts of questions of knowledge are contracted and displayed as root of the tree, and in which different question setting part of questions of knowledge are displayed as a plurality of branches and the contents of recursive branches of the branches (for example, in Judo knowledge, contents of possible WAZA combinations in case of “Only you griped the HIKITE of the opponent” (root) and “your TSURITE is free” (branch)) are simultaneously displayed as (blank filling) questions, where high-leveled person answer all the contents of the second-level branches (IPPONZEOI, grip-also-TSURITE-of-the-opponent, etc.) and low-leveled person answer only the first and most common (frequently used) branch (IPPONZEOI). In this example of Judo, the number of possible WAZAs and the like are more efficiently remembered by the topology of screen displaying the plurality of questions.

In a most typical example, screen of computer is divided into 5 times 4 divisions, and set of pairs of English word and the meaning in Japanese are displayed alternately. Coordinates of divisions correspond to the use-frequencies, i.e. difficulties, of the English words; division (1,1) of up-right is allocated for 250 words that are most frequently used and therefore have to be remembered early; and division (1,2) and (2,1) adjacent to the division (1,1) are, for each, allocated for 250 words (amount 500 words) that are next-level-frequently used; and division (1,3), (2,2) and (3,1) adjacent to the divisions (1,2) and (2,1) are, for each, allocated for 250 words (amount 750 words) that are third-level-frequently used, and so on. And the allocated words and the meanings are displayed in predetermined or random order.

Such most typical arrangement enables natural word arrangement where the words that must be remembered early are few; and the higher the level is, the bigger become the number of words belonging to the level. However, it is not necessarily required that each division has same number of word pair set, we can freely design such matter.

The next typical example is arrangement where y-axis of screen means difficulty and x-axis means position in field sphere or knowledge system. In case of English words, “common”, “life”, “travel”, “society”, “science”, etc. may be field spheres. Moreover, we can divide by the initial letters, pronunciations, and meanings of the words.

Moreover, we can adjust not only position in the screen but also the times when parts of knowledge are displayed on same positions according to difficulties and/or field spheres of the parts of knowledge. For example, absolute order of knowledge displaying, or ordering offsets of display cycle period may be adjusted.

Such division (grouping) of words and adjustment of display positions in screen or display times may be easily made by one skilled in the art with Computer Program such as C language and design of file for memorizing word data etc.

In short, in the present invention, position or order may correspond also to the field sphere of knowledge; and difference of knowledge level, field sphere, or the both may correspond to difference of position in vertical and/or horizontal direction of screen, difference of display order offset of display cycle period, or combination of these difference.

In consequence, by moving eye to less boring direction in case of boring knowledge and by moving eye to easier direction in case of too difficult knowledge, all people can get from the screen new knowledge accordingly to the level of person. Moreover, we can adjust not only position in screen but also timings (absolute order or order offset in display cycle period) of displaying on same positions according to the difficulties and/or field spheres etc., and we can watch appropriate screen divisions at timings (in cycle period) that correspond to our level.

It is preferable that the present invention is applied to display device to which people are not assumed to input anything while they watch the display screen, because such display devices more heavily issue the problem the present invention should solve. That is, once a person sets display knowledge set according only to his level, those who are watching the display screen cannot input temporary short-term level setting while they are watching, there is no chance of displaying knowledge that correspond to the level of other people.

Moreover, it is preferable in the present invention that the display device is connected to computer. Computer is able to electronically control complex displaying of knowledge according to the invention, making whole device inexpensive.

The present invention is preferably implemented as screen display method of screensaver. At many scenes in which screensavers are used, people with different levels of same field knowledge (for example, English words & Chinese words at trading company, computer term at software house, still image or movie of dactylology & the meaning at sign language school, movie of dance step at dance school, etc.) tend to gather.

It is preferable in the present invention that the target knowledge is linguistics knowledge. Linguistic knowledge consists of small unit of knowledge, making it easy to simultaneously display many parts of knowledge on same screen.

It is preferable in the present invention that knowledge be displayed as pair of question and answer, either simultaneously or each one by one. By means of such question and answer, people can reliably check whether they know or not and people can know whether they are watching appropriate position in screen or at offset timing in cyclic period, and get knowledge with pleasure.

Display of question and answer may be one after another (for example, English expression at first, blank-filling expression of corresponding Japanese at the next, whole expression of corresponding Japanese at last).

By such display method, both those who have to remember complete correspondence between English words and Japanese words and those who hope to remember partial knowledge can enjoy question by one same screen. Moreover, same person is able to learn/examine, in the consistent manner, both partially-remembered knowledge and fully-remembered knowledge; and is able to make better use of time while watching screen, by sometimes moving eye to question group with higher level difficulties (for example, EnglishN+1>blank-filling-JapaneseN+1>whole-JapaneseN+1, EnglishN+2>blank-filling-JapaneseN+2>whole-JapaneseN+2, . . . ,EnglishM>blank-fill in g-JapaneseM>whole-JapaneseM) and answer the partially-remembered spelling and the like, in case question group with lower level difficulties paying attention then (for example, English1>blank-filling-Japanese1>whole-Japanese1, English2>blank-filling-Japanese2>whole-Japanese2, . . . ,EnglishN>blank-filling-JapaneseN>whole-JapaneseN) or some of the questions happen to be too easy.

The present invention also provides screen display device comprising means for displaying, simultaneously or one bye one, a plurality of knowledge or information, in particular on a same screen, at different continuous or not-continuous positions or in such order according to the knowledge use frequency, the understanding degree, or the difficulty level.

The present invention also provides the above screen display device wherein said position or said order corresponds also to field spheres of knowledge. The present invention also provides the above screen display device wherein difference of knowledge level, field sphere or the both may correspond to difference of position in vertical and/or horizontal direction of screen, difference of display order offset of display cycle period, or combination of these difference. Moreover such screen display device is preferably display device to which people are not assumed to input anything while they watch the display screen.

Moreover, such display device is preferably connected to computer, and is preferably activated as means of implementing screensaver. And the target knowledge of the screen display device according to the present invention is preferably linguistics knowledge. And it is preferable in the present invention that such device comprises means for displaying knowledge as pair of question and answer, either simultaneously or each one by one. The present invention also provide computer program which make whole or part of computer act as such screen display device.

### BRIEF DESCRIPTION OF DRAWINGS

FIG. 1 is an example of screen according to the present invention, displaying simultaneously expressions of a plurality of linguistics question (answer the meaning of English word in Japanese) according to the difficulties (vertical) and field spheres (horizontal).

FIG. 2 is the same example of screen according to the present invention, displaying partial answers to the questions on corresponding positions of FIG. 1 in blank-filling expression form.

FIG. 3 is the same example of screen according to the present invention, displaying whole answers to the questions on corresponding positions of FIG. 1 and FIG. 2.

### BEST MODE FOR CARRYING OUT THE INVENTION

To explain the present invention in more detail, English-word-Oboeru Screensaver for Microsoft Windows™ will be show below as best embodiment.

If the number of English words to learn is small (for example 500 words), it displays one by one with no problem. However, when the number is larger (for example 10,000 words or more), user must adjust learning level many times, or even if he set broader learning level, display (learning, examination) cyclic period become longer and effect of repeat learning become smaller. Therefore such arrangement as the present invention is preferable.

Control of timing of activation/deactivation of screensaver itself etc. is easy to implement for ones skilled in the art by using library of Microsoft VisualC++ and the like. As to display, by using MFC etc. of the same company, programmer can display every letter everywhere on screen every time.

English word data, meaning in Japanese, division of difficulty level, order of display in belonging division, and field sphere attribute are loaded in CSV form of text when screensaver is activated. For example of data, there are “pen, PEN, difficulty: 1 (correspond to top of screen), 1 (correspond to first question of division), indoor tool (correspond to left of screen)”, “park, KOUEN, difficulty: 1 (correspond to top of screen), 1 (correspond to first question of division), outdoor facility (correspond to second left of screen)”, “desk, TSUKUE, difficulty: 2 (correspond to second top of screen), 1 (correspond to first question of division), indoor tool (correspond to left of screen)” and so on. By programming such that computer load, at once and for all, all the questions including questions which will be displayed as second or later questions for displaying continuously, the present invention gives efficient and continuous learning effect without giving user any chance of diverting his attention from screen.

After that, the present invention continue to display (and clear), one bye one, English words and meanings in Japanese at corresponding coordinates according to difficulty level division (i.e. correspond to y-axis (up, middle, down)) and field sphere attributes, and moreover display order within the division (first question, second or later). If it has displayed last word within the belonging division (for example, difficulty: 1 (top of screen) and outdoor facility (second left)), it initialize index variable (global variable of C language) that memorize question number of the division to 0 and it return to displaying first word. Such programming technique is clear for ones skilled in the art.

For example, at coordinate (1,1)=(difficulty: 1, indoor tool), as the second question which is next to “pen”, question corresponding to “eraser” (KESHIGOMU) is displayed, and after displaying last question (and answer), it returns to first question of “pen”.

As a control of screensaver embodiment of plural display according to the present invention, it memorize, for each difficulty and each field sphere, order numbers of questions which are being displayed when screensaver stop because of some input, enabling start at the memorized order numbers or the next order numbers.

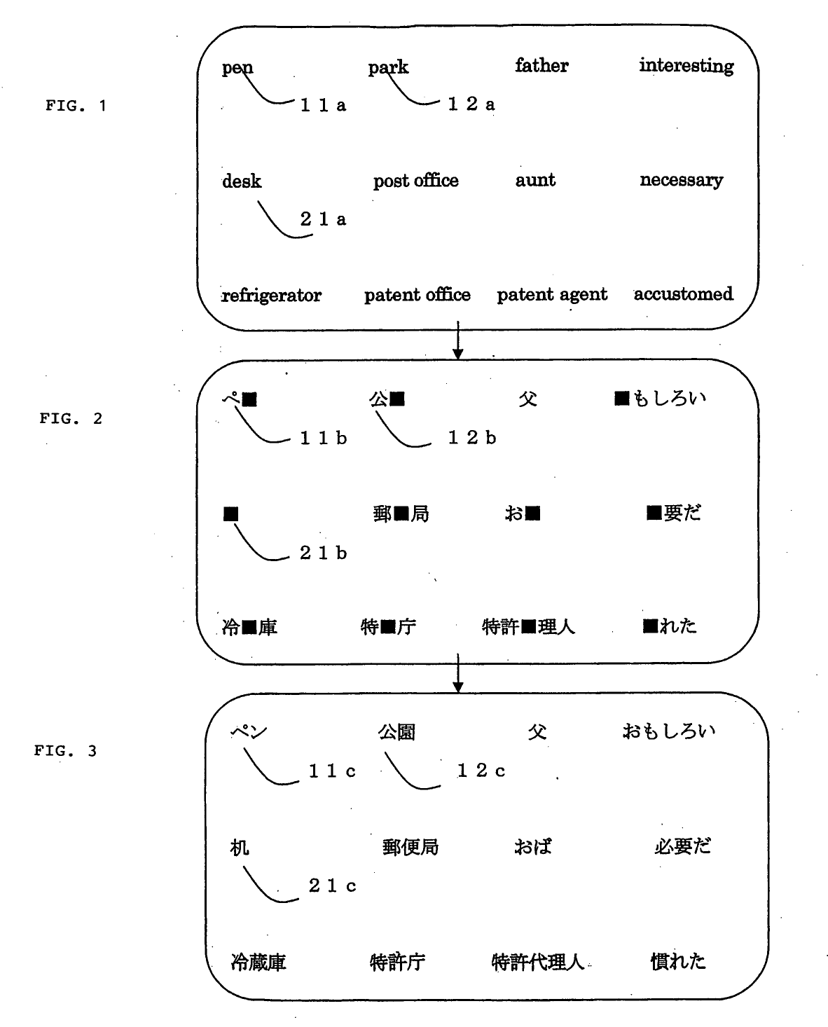

As to correspondence between divisions and coordinates, if division depends only on difficulties, the embodiment differs from that of FIG. 1-3. In this case, difficulty: 1 may occupy coordinate (1,1), and difficulty: 2 may occupy (1,2) and (2,1), and difficulty: 3 may occupy (1,3), (2,2) and (3,1). Or, difficulty: 1 may occupy (1,1), and difficulty: 2 may occupy (1,2), and difficulty: 3 may occupy (2,1), and difficulty: 4 may occupy (1,3), and difficulty: 5 may occupy (2,2), and difficulty: 6 may occupy (3,1) and so on. Moreover symmetries to such arrangements are easily available.

As to order of question, sometimes random order is meaningful. In such case, program does not need to refer to the above display order information, and the present invention easily select and display question from set of questions that are required to be displayed at the belonging division, at random by using random number generator library.

In the prior art of display control by computer program, it is easy to group a plurality of knowledge, memorize them with group identifications and display them at (determined) every (or random) position on screen and at (determined) every (or random) time. The theme of the present invention is not such technique, but, while displaying knowledge (and/or information) using such technique, (in particular) continuity of arrangement and timing according to (in particular) the difficulties of knowledge. However, even in case of no continuity, if topology policy within the screen can be guessed or if each member of family loves each determined position of screen, displaying plurality at determined positions itself is useful.

Therefore, as long as continuity as to screen position exists, such topology policy that center of screen is easy and margin is difficult or that knowledge become difficult in a spiral way or their reverse policies and the like fall into the scope of the present invention.

Even if the screen is not rectangle (or is rectangle of course), in case of designing arrangement of knowledge so that user guess some logical meaning of the arrangement, user can seek useful positions for the user and enjoy the depth of contents even when it was implemented as (in particular) screensaver. Moreover, dynamic change of arrangement also fall into scope of the present invention and the purpose of the invention will be achieved even in such case.

### INDUSTRIAL APPLICABILITY

As mentioned before, the present invention may be broadly used on the spot (many) people stay, in the fields of learning and/or amusement, or as screensaver for learning and the like.

1. Screen display method, characterized in that it displays, simultaneously or one bye one, a plurality of knowledge (11a, 12a, 21a) or information (hereinafter, we call them simply as knowledge), in particular on same screen of (temporary) environment to which those who watch the screen are not assumed to input anything, at different continuous or not-continuous positions or in such order (11a, 21a) according to the knowledge use frequency, the understanding degree, or the difficulty level.

2. Screen display method according to claim 1, wherein said position or said order (11a, 12a) corresponds also to field spheres of knowledge.

3. Screen display method according to claim 1 or 2, wherein difference of knowledge level, field sphere or the both may correspond to difference of position in vertical and/or horizontal direction of screen, difference of display order offset of display cycle period, or combination of these difference.

4. Screen display method according to one of claims 1 to 3, where the method is applied to display device to which people are not assumed to input anything while they watch the display screen.

5. Screen display method according to claim 4, wherein said display device is connected to computer.

6. Screen display method according to one of claims 1 to 5, wherein the method is implemented as screen display method of screensaver.

7. Screen display method according to one of claims 1 to 6, wherein said knowledge is linguistics knowledge (11a, 11c).

8. Screen display method according to one of claims 1 to 7, wherein knowledge is displayed as pair of question (11a, 11b) and answer (11c), either simultaneously (11a, 12a, 21a, 11b, 12b, 21b, 21c, 12c, 21c) or each one by one.

9. Screen display method according to one of claims 1 to 8, wherein it displays tree in which common question setting parts of questions of knowledge are contracted as root of the tree and in which different question setting part of questions of knowledge are displayed as a plurality of branches and the contents of the branches or the contents of recursive branches of the branches are simultaneously displayed as (blank filling) questions.

10. Screen display device, comprising means for displaying, simultaneously or one bye one, a plurality of knowledge, in particular on same screen of (temporary) environment to which those who watch the screen are not assumed to input anything, at different continuous or not-continuous positions or in such order according to the knowledge use frequency, the understanding degree, or the difficulty level.

11. Screen display device according to claim 10, wherein said position or said order corresponds also to field spheres of knowledge.

12. Screen display device according to claim 10 or 11, wherein difference of knowledge level, field sphere or the both may correspond to difference of position in vertical and/or horizontal direction of screen, difference of display order offset of display cycle period, or combination of these difference.

13. Screen display device according to one of claims 10 to 12, to which people are not assumed to input anything while they watch the display screen.

14. Screen display device according to claim 13 that is connected to computer.

15. Screen display device according to one of claims 10 to 14, that is activated as means for implementing screensaver.

16. Screen display device according to one of claims 10 to 15, wherein said knowledge is linguistics knowledge.

17. Screen display device according to one of claims 10 to 16, comprising means for displaying knowledge as pair of question and answer, either simultaneously or each one by one.

18. Screen display device according to one of claims 10 to 17, wherein it displays tree in which common question setting parts of questions of knowledge are contracted as root of the tree, and in which different question setting part of questions of knowledge are displayed as a plurality of branches and the contents of the branches or the contents of recursive branches of the branches are simultaneously displayed as (blank filling) questions.

19. Computer program for making whole or part of computer act as screen display device according to one of claims 10 to 18.
